(19) United States
(12) Patent Application Publication
(10) Pub. No.: US 2025/0252433 A1
(43) Pub. Date: Aug. 7, 2025

(54) NON-FUNGIBLE TOKEN FOR AUTOMATIC EXECUTION OF ASPECTS OF AN ESTATE

(71) Applicant: Wells Fargo Bank, N.A., San Francisco, CA (US)

(72) Inventors: Ray Joanna Luz Reyes Ramilo, Paranaque (PH); Indranil Das, Sunnyvale, CA (US); Krishnamraju V. Penmetcha, Mountain View, CA (US); Ling Yee Lindy Sin, San Francisco, CA (US); Sadie S. Salim, Mill Valley, CA (US); Marc R. Ward, Livermore, CA (US)

(21) Appl. No.: 17/823,692

(22) Filed: Aug. 31, 2022

(51) Int. Cl. G06Q 20/38; G06Q 20/40; G06Q 50/18

(52) U.S. Cl. CPC G06Q 20/389; G06Q 20/405; G06Q 50/186

(57) ABSTRACT

Systems and methods may generally provide a non-fungible token for automatic execution of aspects of an estate. An example method may include receiving information from a user, corresponding to a financial asset, the information identifying a right to be conferred to an entity on occurrence of a trigger event, generating a non-fungible token encapsulating the right to be conferred to the entity related to the financial asset, and storing the non-fungible token on a secure chain at a server. The example method may include determining whether the trigger event related to the user has occurred, and automatically outputting, in response to determining the trigger event has occurred, an indication of the non-fungible token to the entity.

### BACKGROUND

A non-fungible token (NFT) is a unique digital asset that includes information, a file, etc. NFTs are often stored in a distributed ledger, such as a blockchain. NFTs may be publicly accessible and tradeable or privately held. A distributed ledger may include a validation of an NFT (e.g., validate a transaction or block involving an NFT). An NFT may be associated with metadata stored on the distributed ledger, such as an owner of the NFT.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an example representation of a non-fungible token in accordance with some embodiments.

FIG. 2 illustrates a ledger including example block entries for tracking aspects of an estate in accordance with some embodiments.

FIG. 3 illustrates a chain of a distributed ledger in progress in accordance with some embodiments.

FIGS. 4A-4B illustrate user interfaces for interacting with a block entry (e.g., a non-fungible token) in accordance with some embodiments.

FIG. 5 illustrates a flowchart showing a technique for providing a non-fungible token for automatic execution of aspects of an estate in accordance with some embodiments.

FIG. 6 illustrates generally an example of a block diagram of a machine upon which any one or more of the techniques discussed herein may perform in accordance with some embodiments.

### DETAILED DESCRIPTION

The systems and techniques described herein provide a technological framework to facilitate creation, storage, and use of a non-fungible token (NFT), such as in a distributed ledger (e.g., a blockchain). The NFT may indicate an asset of an owner, which may be transferred based on a trigger event.

The systems and techniques described herein solve several technological problems, such as delays in computing systems or obstacles to transferring funds or legal rights. For example, facilitating transfer of money for funeral arrangements, immediate bills, or expenses when a person dies or is incapacitated is often made difficult by lack of automation. Another technological problem includes that the executor or trustee is a gatekeeper of an estate or trust, and may need to be physically present to transfer some assets in some cases. The executor or trustee may be unable, unwilling, or not an optimal choice of a person to deal with a particular task, which leads to delays. To overcome these issues, a will or advanced directive may be stored on a blockchain, particularly as an NFT. For example, an advanced directive may be stored as an NFT, with various attributes, such as a recipient (e.g., to perform the directive), information related to the directive such as an account name or number, a password, access code, etc., or the like. The NFT may transfer on death or incapacitation. In some examples, a person may initiate an NFT transfers (e.g., the executor, who may more quickly initiate a transfer of an NFT than another transfer action, which may require a physical visit to a bank, for example). In some examples, the NFT may be transferred automatically or with an automated executor (e.g., a bot pre-selected by the user).

An example NFT may include access to a $5,000 bank account to pay for funeral expenses. This example NFT may be sent to someone other than a family member or the executor, so that the bills for the funeral may be paid without further burdening the family of the deceased. Another example NFT may include an advanced health directive, which executes not on death, but on incapacitation. This NFT may go to someone other than the executor, in some examples. This NFT may be kept secret from the person receiving it until the incapacitation occurs, for example.

In some examples, one or more components of an estate may be embodied in an NFT (e.g., each real estate item, each vehicle, each set of personal property, each account, etc.). Components of an estate may be combined in a single NFT in some examples. Assets may transfer to heirs and assigns automatically based on a smart contract in some examples, such as one stored in a block, which may direct NFT transfers.

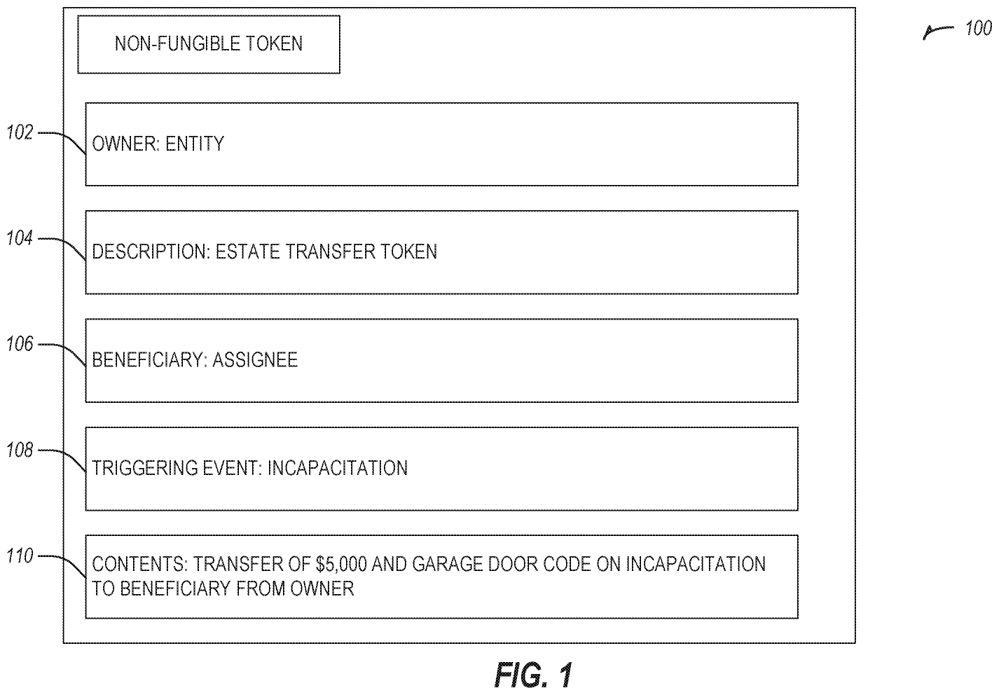

FIG. 1 illustrates an example representation of an NFT 100 in accordance with some embodiments. The NFT 100 is shown in FIG. 1 with corresponding information, but in some examples, the information or parts of the corresponding information may be stored not in the NFT 100. For example, some information may be metadata stored with the NFT 100, such as in a block of a ledger.

The information stored in or with the NFT 100 in the example shown in FIG. 1 includes an owner entry 102, a description entry 104, a beneficiary entry 106, a triggering event entry 108, and a contents entry 110. In some examples, one or more of these entries may be omitted or blank. One or more additional entries may be used with the NFT 100. The entries shown in FIG. 1 include example values. The owner entry 102 is shown with a value of “entity”, which may include a person, a company, a group of people, a legal entity, or the like. The description entry 104 indicates a type for the NFT 100. The type for NFT 100 includes an “estate transfer token”. Other example NFT 100 types may include an incapacitation transfer token, a temporary transfer token, etc. The beneficiary entry 106 shows the receiver of the contents referred to in the NFT 100 when the triggering event occurs, the “assignee”, which may include a person, a company, a group of people, a legal entity, an indication of a future person (e.g., “my issue”), or the like.

The triggering event entry 108 identifies what causes transfer of the contents of the NFT 100 from the entity to the assignee. The triggering event entry 108 for NFT 100 includes incapacitation. This may include incapacitation of the entity, incapacitation of another (e.g., when the entity holds the contents in trust or when a minor is involved), death of an individual, or the like. Incapacitation may be defined in the NFT 100 (e.g., in the triggering event entry 108) or elsewhere (e.g., in a will, a living will, a healthcare power of attorney form, etc.). When the triggering event occurs, the contents of the NFT 100 may be caused to transfer from the entity to the assignee. The transfer of the contents may include manual transfer by a user or may be automatically transferred (e.g., in response to a receipt of an indication of the trigger event). Automatic transfer may include sending a message (e.g., an email, mail, a text message, etc.) when the contents include information. Automatic transfer may include executing aspects of a smart contract, in some examples. Automatic transfer may include a legal transfer (e.g., of a physical asset, such as a car or a non-physical asset, such as a bank account).

The contents entry 110 may include information to be transferred or describe information or assets to be transferred. In the example of FIG. 1, the contents entry 110 includes transfer of money and a digital asset (garage door code). The contents entry 110 may include information related to how or when the contents are to be transferred, such as when the incapacitation trigger event is identified, sending the contents to a beneficiary from an owner. In other examples, the contents may include a bank account, personal property (e.g., a car, clothes, a sentimental object, etc.), real property (e.g., a house, land, etc.), a password, instructions, information, digital currency (e.g., Bitcoin, Ethereum, etc.), or the like

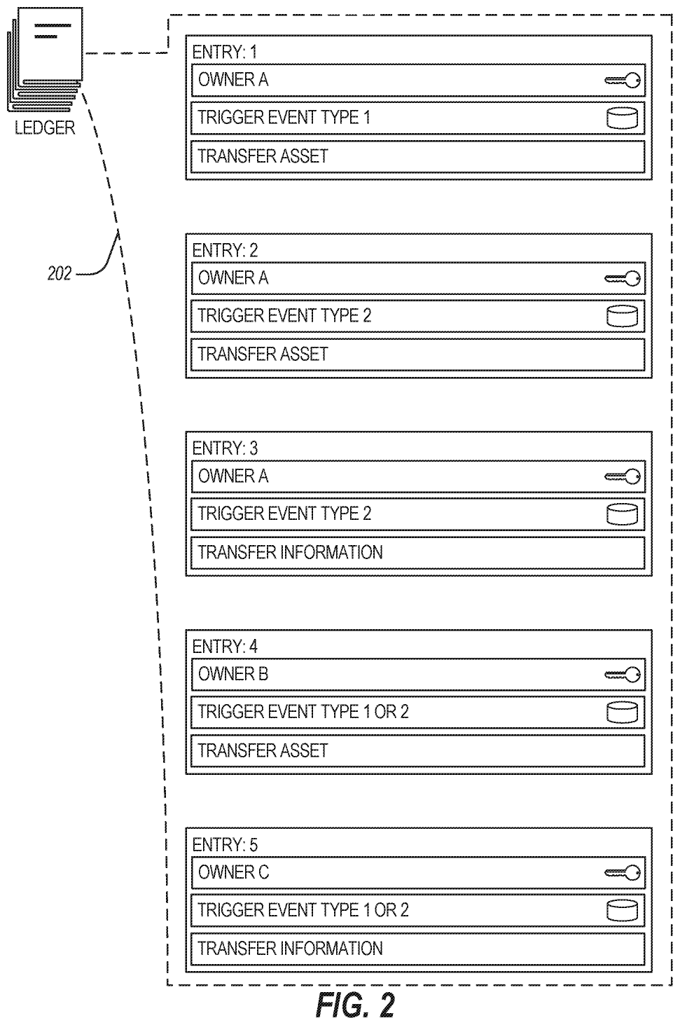

FIG. 2 illustrates a ledger 202 including example block entries for tracking aspects of an estate in accordance with some embodiments. The ledger 202 includes a plurality of blocks, which may be used to store one or more NFTs. In some examples, the ledger 202 may correspond to a single user. In other examples, the ledger 202 may correspond to a group of users (e.g., all users of a financial institution, a group of people such as a family, etc.). In the example shown in FIG. 2, the ledger 202 includes three owners A, B, and C, which may represent a family.

Each block in the ledger 202 may correspond to a transaction (a data creation event), an entity (e.g., a person, a company, a group of users, etc.), or an asset (e.g., a bank account, real estate, a stock account such as a 401k, a password, a location of a physical asset, etc.). The ledger 202 includes example blocks, such as entry 1 having owner A, trigger event type 1, and an indication of an action to be taken in response to the trigger event-transfer an asset. The trigger event type may be identified across the ledger 202, or may be specified within each entry. Other entries in the ledge 202 include a second trigger event type (e.g., incapacitation or death of a user), and entries 4 and 5 include both types (e.g., either trigger event occurring will trigger the transfer). Entries 3 and 5 include transfer of information instead of an asset. In an example entry, both an asset and information may be transferred. Each entry in the ledger 202 may include an NFT.

An encryption scheme may be used with the ledger 202 to cryptographically sign or encrypt a block to keep the information in the block secure, and only accessible by intended parties. An example encryption includes Public Key Infrastructure (PKI), which may be implemented using an open-source certificate authority or certification authority, such as OpenCA from OpenCA PKI Research Labs. When two parties communicate using public-key encryption, the sender uses the public key belonging to the recipient and uses it to encrypt the information. On receipt of the encrypted data, the recipient uses a private key to decrypt, and thereby access the information.

In another example, the ledger 202 may be distributed (but still optionally stored using encryption, such as by hashing), and the distribution (e.g., using a blockchain with voting) may prevent changes to the ledger 202. The blocks may be stored and voted on in an encrypted format, such that they are not accessible (except to an authorized auditor or other party holding decryption keys). In an example, signing a block may revoke write access to a database, while read access is permitted. An attempt to edit a signed block may not be possible or may result in the voting identifying an unauthorized change. For example, other voters may reject a changed block as not ‘truth’ within the blockchain, and not allow the change to proceed. A timing mechanism may be used to allow changes to a signed block by the signing entity within a particular time frame (e.g., within a few minutes, an hour, a day, a week, etc.), but prevent changes after that time frame.

The ledger 202 may store blocks with encrypted information such that the information is inaccessible to anyone except the owner of the entry. In some examples, the ledger 202 may be stored privately (e.g., on a secure server or set of servers of an entity, such as a bank). In other examples, the ledger 202 may be distributed (e.g., when entries are encrypted).

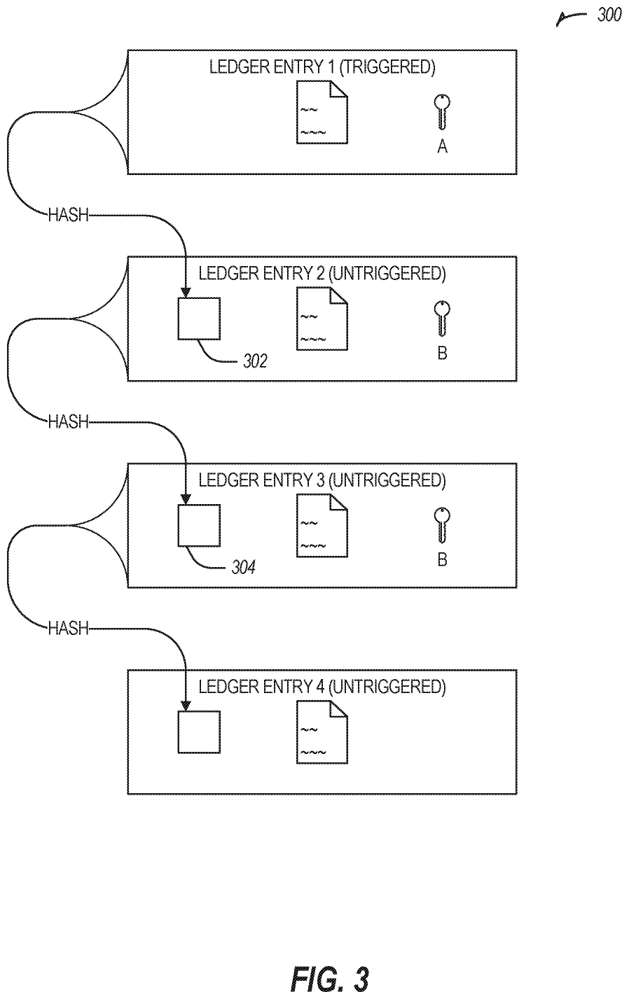

FIG. 3 illustrates a chain of a distributed ledger 300 in progress in accordance with some embodiments. The entry 4 may include data that has been added or is in progress, but not yet encrypted or signed. The other entries 1-3 in the ledger 300 are represented as having been signed or encrypted. Entries 2 and 3 are shown as being signed or encrypted with key B, which may correspond to a single entity (e.g., the entity closed both entries) or a type of entry (e.g., stronger security for banking assets, weaker security for a garage code), while entry 1 was closed with key A.

Each subsequent entry is shown as storing the previous entry (which may be optionally hashed, as shown in FIG. 3). For example, box 302 is a hashed representation of entry 1. Box 304 is a hashed representation of entry 2, which necessarily includes the hashed presentation of entry 1 (because entry 2 includes box 302). Thus, ledger 300 may be stored by saving a version of the last block in the ledger 300 (e.g., a hashed version of the last block).

The ledger 300 may be distributed, such that it is stored in multiple locations or by multiple entities. Each entity or location may vote on the ‘truth’ of the ledger 300, where a majority or a super majority of the voting entities or locations describes the ‘truth’ of the ledger 300. When a change is made (e.g., unauthorized or accidental) by one entity or location, the other entities or locations reject the change by voting against that version of the ledger 300. Thus, unauthorized or accidental changes cannot be made to the ledger 300 (except in extreme cases where multiple entities or locations collude).

A central database may store a table with signing information related to each of the blocks. For example, a hash table or a key table may be stored at the central database to maintain which hashes or keys were used for each block. In an example, an entity that maintains the central database may control access to the ledger 300. For example, an entity that creates or modifies (e.g., saves data to) a block may be prevented from accessing other blocks in the ledger 300. For example, each block may be hashed such that an entity creating a next block can save the hashed previous block but cannot access its contents. Voting by entities may be based on hashed values for each block, rather than contents of the block, allowing for blockchain verification without exposing data. The entity maintaining the central database may have access to all blocks, or at least read access to all blocks, so an audit may be performed. The audit may include querying entities of the blockchain storing the ledger 300 to ensure that the audited copy of the ledger 300 that is accessible to the auditor is verified by the other entities.

The entries are indicated as being triggered or untriggered, although this is optional. The triggered ledger entry 1 may be locked to prevent any further editing in response to being triggered. The untriggered entries may be changeable or locked. When changeable, a fork in the chain may occur. For example, if entry 2 is changed, then box 304 will no longer be a hashed representation of entry 2, and thus a new chain may branch from ledger entry 2, with a new ledger entry 3 including a new version of box 304 that accurately represents ledger entry 2. This new chain may include a new ledger entry 4 as well. Both branches of the forked chain may be stored, such that the old chain may be referenced. In other examples, instead of forking the ledger 300, subsequent entries in the chain may be updated (e.g., box 304 may be updated at ledger entry 3 when ledger entry 2 changes).

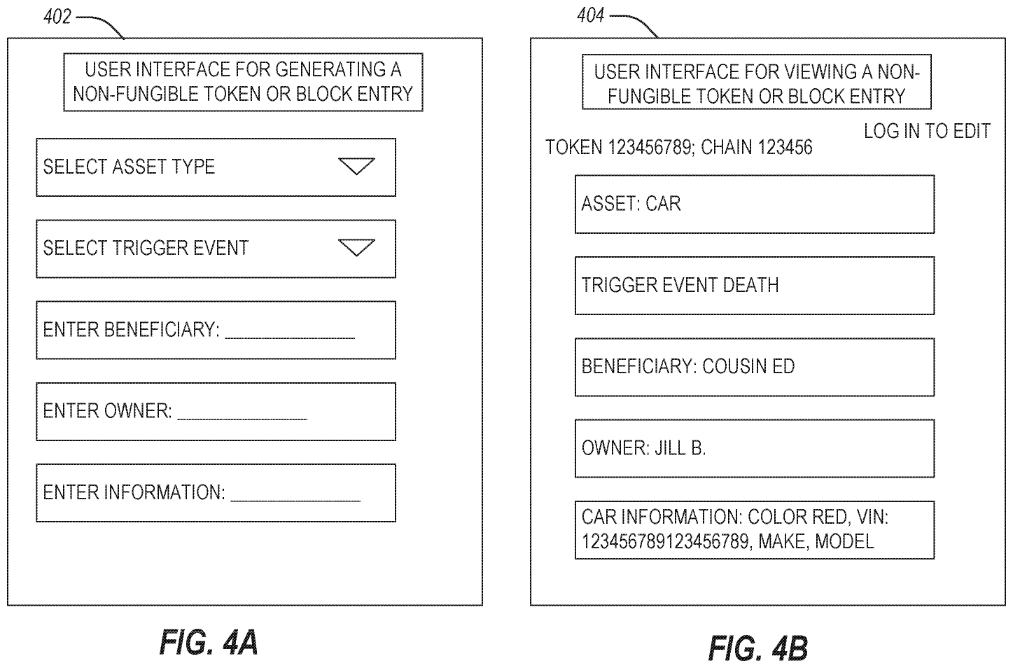

FIGS. 4A-4B illustrate user interfaces 402 and 404 for interacting with a block entry (e.g., a non-fungible token) in accordance with some embodiments.

The user interface 402 may be used to generate an NFT or block entry (e.g., in a blockchain). The user interface 402 includes various user interface components for providing information corresponding to an NFT or block, such as selectable options for asset type or trigger event, and text entry options for beneficiary, owner, or other information. The information entered in the user interface 402 may be captured and used to generate an NFT or block. The selectable options may be limited, for example based on a user status or attribute, a type of NFT selected, limits or attributes of a particular blockchain (e.g., a blockchain may be limited to asset type or trigger event), a previously or concurrently selected option (e.g., if the asset type is homestead real property, the trigger event may be limited to only “on death”), or the like.

The user interface 404 may be used to view an NFT or block entry, such as with previously entered details. In some examples, the user interface 404 may be used to edit the NFT or block (e.g., when a user is logged in). In other examples, the NFT or block may not be modified by user edits, although the NFT or block may be edited via transfer, triggering the trigger event, or the like. The user interface 404 includes an example asset of a car, with a trigger event being the death of the owner, Jill B. On death of the owner, the car transfers to Cousin Ed. The user interface 404 shows additional information about the car, which may be hidden or encrypted, such as color, VIN, Make, Model, etc. In some examples, the information may include a location of a title, insurance information, or other metadata about the car (e.g., a garage code). The user interface 404 shows a token number for the NFT shown, as well as a chain identifier (e.g., where the NFT is stored).

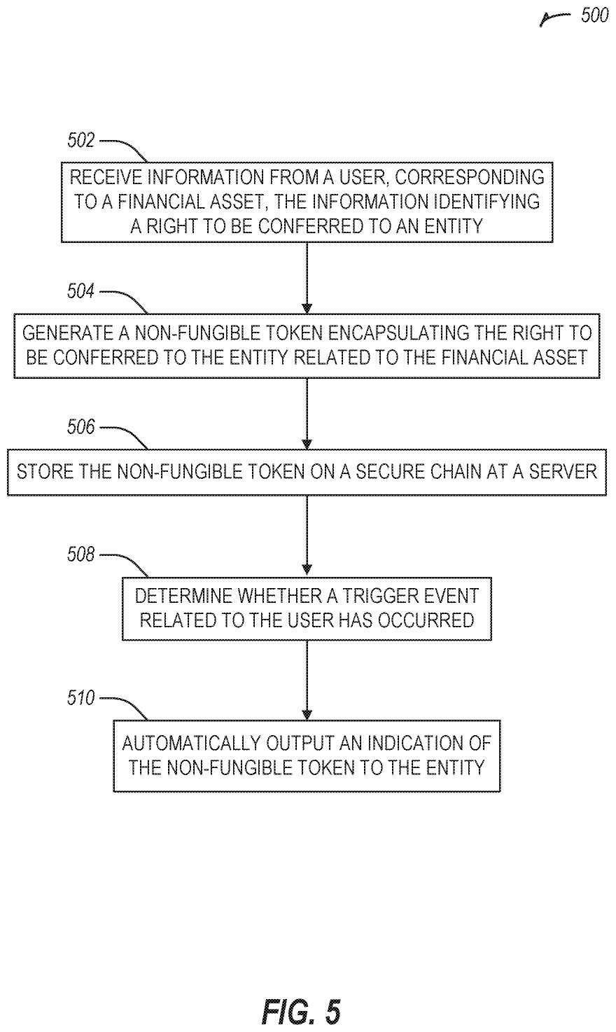

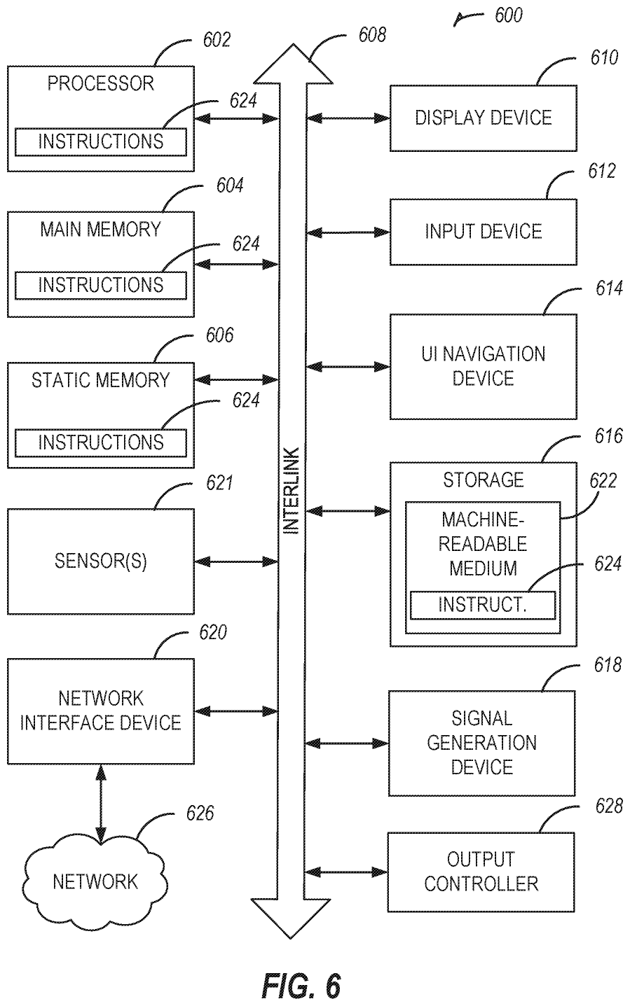

FIG. 5 illustrates a flowchart showing a technique 500 for providing a non-fungible token for automatic execution of aspects of an estate in accordance with some embodiments. In an example, operations of the technique 500 may be performed by processing circuitry, for example by executing instructions stored in memory. The processing circuitry may include a processor, a system on a chip, or other circuitry (e.g., wiring). For example, technique 500 may be performed by processing circuitry of a device (or one or more hardware or software components thereof), such as those illustrated and described with reference to FIG. 6.

The technique 500 includes an operation 502 to receive information from a user, corresponding to a financial asset, the information identifying a right to be conferred to an entity. The entity may include a person, a group of people, a company, etc. The financial asset may include a bank account, a retirement account, a real estate holding, or the like. The right may transfer legal title to the financial asset.

The technique 500 includes an operation 504 to generate a non-fungible token encapsulating the right to be conferred to the entity related to the financial asset. Operation 504 may include encapsulating a non-financial asset to be granted to the entity, such as a password or an access code. Operation 504 may include encapsulating a financial power of attorney to the entity over the financial asset. In some examples, operation 504 includes generating a representation of the non-fungible token in a virtual reality environment. The virtual reality environment may include a metaverse (e.g., the Metaverse of Facebook, Inc.).

The technique 500 includes an operation 506 to store the non-fungible token on a secure chain at a server. The non-fungible token may be stored on multiple servers, for example according to a blockchain protocol (e.g., as discussed above). The non-fungible token may include a smart contract conferring the right. The smart contract may be caused to execute (e.g., instead of or during operation 510, such as when automatically outputting the indication).

The technique 500 includes an operation 508 to determine whether a trigger event related to the user has occurred. The trigger event may include an incapacitation or death of a user, a health event related to the user (e.g., a scheduled surgery), or the like. When the trigger event is death of the user, the right may be conferred to the entity outside of probate. When the trigger event is incapacitation of the user, granting the right may include granting a healthcare advanced directive power of attorney to the entity. The trigger event may be determined based on a user input (e.g., uploading a death certificate, entering text corresponding to a trigger event, etc.), automatically (e.g., identification of existence of a death certificate in an online database, a time period expiration, etc.), based on input from a trusted authority (e.g., a coroner, a doctor, etc.), or the like.

The technique 500 includes an operation 510 to automatically output an indication of the non-fungible token to the entity, for example in response to determining the trigger event has occurred in operation 508. In an example, the technique 500 includes receiving, in response to automatically outputting the indication, a rejection of the right from the entity. In this example, the technique 500 may include transferring the right to a second entity. The second entity may be specified in the non-fungible token in some examples (e.g., a list of entities).

FIG. 6 illustrates generally an example of a block diagram of a machine 600 upon which any one or more of the techniques (e.g., methodologies) discussed herein may perform in accordance with some embodiments. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit 610, an alphanumeric input device 612 (e.g., a keyboard), and a user interface (UI) navigation device 614 (e.g., a mouse). In an example, the display unit 610, alphanumeric input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a machine readable medium 622 that is non-transitory on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software.

The following, non-limiting examples, detail certain aspects of the present subject matter to solve the challenges and provide the benefits discussed herein, among others.

Example 1 is a method comprising: receiving information from a user, corresponding to a financial asset, the information identifying a right to be conferred to an entity on occurrence of a trigger event; generating, at a processor, a non-fungible token encapsulating the right to be conferred to the entity related to the financial asset; storing the non-fungible token on a secure chain at a server; determining whether the trigger event related to the user has occurred; and automatically outputting, in response to determining the trigger event has occurred, an indication of the non-fungible token to the entity.

In Example 2, the subject matter of Example 1 includes, wherein the trigger event is death of the user, and wherein the right is conferred to the entity outside of probate.

In Example 3, the subject matter of Examples 1-2 includes, wherein the trigger event is incapacitation of the user and wherein granting the right includes granting a healthcare advanced directive power of attorney to the entity.

In Example 4, the subject matter of Examples 1-3 includes, wherein generating the non-fungible token includes encapsulating a non-financial asset to be granted to the entity, the non-financial asset including at least one of a password or an access code.

In Example 5, the subject matter of Examples 1-4 includes, wherein generating the non-fungible token includes encapsulating a financial power of attorney to the entity over the financial asset.

In Example 6, the subject matter of Examples 1-5 includes, wherein the financial asset is a bank account, a retirement account, or a real estate holding, and wherein the right transfers legal title to the financial asset.

In Example 7, the subject matter of Examples 1-6 includes, wherein the non-fungible token includes a smart contract conferring the right, and wherein automatically outputting the indication includes causing the smart contract to execute.

In Example 8, the subject matter of Examples 1-7 includes, receiving, in response to automatically outputting the indication, a rejection of the right from the entity; and transferring the right to a second entity.

In Example 9, the subject matter of Examples 1-8 includes, wherein generating the non-fungible token includes generating a representation of the non-fungible token in a virtual reality environment.

Example 10 is at least one non-transitory machine-readable medium including instructions, which when executed by processing circuitry, cause the processing circuitry to perform operations to: receive information from a user, corresponding to a financial asset, the information identifying a right to be conferred to an entity on occurrence of a trigger event; generate a non-fungible token encapsulating the right to be conferred to the entity related to the financial asset; store the non-fungible token on a secure chain at a server; determine whether the trigger event related to the user has occurred; and automatically output, in response to determining the trigger event has occurred, an indication of the non-fungible token to the entity.

In Example 11, the subject matter of Example 10 includes, wherein the trigger event is death of the user, and wherein the right is conferred to the entity outside of probate.

In Example 12, the subject matter of Examples 10-11 includes, wherein the trigger event is incapacitation of the user and wherein operations to grant the right include operations to grant a healthcare advanced directive power of attorney to the entity.

In Example 13, the subject matter of Examples 10-12 includes, wherein operations to generate the non-fungible token include operations to encapsulate a non-financial asset to be granted to the entity, the non-financial asset including at least one of a password or an access code.

In Example 14, the subject matter of Examples 10-13 includes, wherein operations to generate the non-fungible token include operations to encapsulate a financial power of attorney to the entity over the financial asset.

In Example 15, the subject matter of Examples 10-14 includes, wherein the financial asset is a bank account, a retirement account, or a real estate holding, and wherein the right transfers legal title to the financial asset.

In Example 16, the subject matter of Examples 10-15 includes, wherein the non-fungible token includes a smart contract conferring the right, and wherein operations to automatically output the indication include operations to cause the smart contract to execute.

In Example 17, the subject matter of Examples 10-16 includes, operations to: receive, in response to automatically outputting the indication, a rejection of the right from the entity; and transfer the right to a second entity.

In Example 18, the subject matter of Examples 10-17 includes, wherein operations to generate the non-fungible token include operations to generate a representation of the non-fungible token in a virtual reality environment.

Example 19 is a device comprising: processing circuitry; and memory including instructions, which when executed by the processing circuitry, cause the processing circuitry to perform operations to: receive information from a user, corresponding to a financial asset, the information identifying a right to be conferred to an entity on occurrence of a trigger event; generate a non-fungible token encapsulating the right to be conferred to the entity related to the financial asset; store the non-fungible token on a secure chain at a server; determine whether the trigger event related to the user has occurred; and automatically output, in response to determining the trigger event has occurred, an indication of the non-fungible token to the entity.

In Example 20, the subject matter of Example 19 includes, wherein the non-fungible token includes a smart contract conferring the right, and wherein operations to automatically output the indication include operations to cause the smart contract to execute.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

1. A method comprising:
receiving information from a user, corresponding to a financial asset, the information identifying a right to be conferred to an entity on occurrence of an incapacitation trigger event;
generating, at a processor, a non-fungible token encapsulating the right to be conferred to the entity related to the financial asset;
storing the non-fungible token in a block on a secure chain at a server, the secure chain using an encryption scheme to hash the block;
determining the incapacitation trigger event related to the user has occurred;
verifying the block based on the hash;
automatically outputting, in response to the determining the incapacitation trigger event has occurred, an indication of the non-fungible token to the entity, wherein the non-fungible token is kept secret from the entity by the encryption scheme until after determining the incapacitation trigger event has occurred; and
automatically transferring content of the non-fungible token to the entity by executing a smart contract stored in the non-fungible token.

2. The method of claim 1, wherein the incapacitation trigger event is death of the user, and wherein the right is conferred to the entity occurs outside of probate.

3. The method of claim 1, wherein the incapacitation trigger event is incapacitation of the user and wherein granting the right includes granting a healthcare advanced directive power of attorney to the entity.

4. The method of claim 1, wherein generating the non-fungible token includes encapsulating a non-financial asset to be granted to the entity, the non-financial asset including at least one of a password or an access code.

5. The method of claim 1, wherein generating the non-fungible token includes encapsulating a financial power of attorney to the entity over the financial asset.

6. The method of claim 1, wherein the financial asset is a bank account, a retirement account, or a real estate holding, and wherein the right transfers legal title to the financial asset.

7. The method of claim 1, wherein the non-fungible token includes a smart contract conferring the right, and wherein automatically outputting the indication includes causing the smart contract to execute.

8. The method of claim 1, further comprising:
receiving, in response to automatically outputting the indication, a rejection of the right from the entity; and
transferring the right to a second entity.

9. The method of claim 1, wherein generating the non-fungible token includes generating a representation of the non-fungible token in a virtual reality environment.

10. At least one non-transitory machine-readable medium including instructions, which when executed by processing circuitry, cause the processing circuitry to perform operations to:
receive information from a user, corresponding to a financial asset, the information identifying a right to be conferred to an entity on occurrence of an incapacitation trigger event;
generate a non-fungible token encapsulating the right to be conferred to the entity related to the financial asset;
store the non-fungible token in a block on a secure chain at a server, the secure chain using an encryption scheme to hash the block;
determine the incapacitation trigger event related to the user has occurred;
verify the block based on the hash;
automatically output, in response to the determination the incapacitation trigger event has occurred, an indication of the non-fungible token to the entity, wherein the non-fungible token is kept secret from the entity by the encryption scheme until after determining the incapacitation trigger event has occurred; and
automatically transfer content of the non-fungible token to the entity by executing a smart contract stored in the non-fungible token.

11. The at least one non-transitory machine-readable medium of claim 10, wherein the incapacitation trigger event is death of the user, and wherein the right is conferred to the entity outside of probate.

12. The at least one non-transitory machine-readable medium of claim 10, wherein the incapacitation trigger event is incapacitation of the user and wherein operations to grant the right include operations to grant a healthcare advanced directive power of attorney to the entity.

13. The at least one non-transitory machine-readable medium of claim 10, wherein operations to generate the non-fungible token include operations to encapsulate a non-financial asset to be granted to the entity, the non-financial asset including at least one of a password or an access code.

14. The at least one non-transitory machine-readable medium of claim 10, wherein operations to generate the non-fungible token include operations to encapsulate a financial power of attorney to the entity over the financial asset.

15. The at least one non-transitory machine-readable medium of claim 10, wherein the financial asset is a bank account, a retirement account, or a real estate holding, and wherein the right transfers legal title to the financial asset.

16. The at least one non-transitory machine-readable medium of claim 10, wherein the non-fungible token includes a smart contract conferring the right, and wherein operations to automatically output the indication include operations to cause the smart contract to execute.

17. The at least one non-transitory machine-readable medium of claim 10, further operations to:
receive, in response to automatically outputting the indication, a rejection of the right from the entity; and
transfer the right to a second entity.

18. The at least one non-transitory machine-readable medium of claim 10, wherein operations to generate the non-fungible token include operations to generate a representation of the non-fungible token in a virtual reality environment.

19. A device comprising:
processing circuitry; and
memory including instructions, which when executed by the processing circuitry, cause the processing circuitry to perform operations to:
receive information from a user, corresponding to a financial asset, the information identifying a right to be conferred to an entity on occurrence of an incapacitation trigger event;
generate a non-fungible token encapsulating the right to be conferred to the entity related to the financial asset;
store the non-fungible token in a block on a secure chain at a server, the secure chain using an encryption scheme to hash the block;
determine the incapacitation trigger event related to the user has occurred;
verify the block based on the hash;
automatically output, in response to the determination the incapacitation trigger event has occurred, an indication of the non-fungible token to the entity, wherein the non-fungible token is kept secret from the entity by the encryption scheme until after determining the incapacitation trigger event has occurred; and
automatically transferring content of the non-fungible token to the entity by executing a smart contract stored in the non-fungible token.

20. The device of claim 19, wherein the non-fungible token includes a smart contract conferring the right, and wherein operations to automatically output the indication include operations to cause the smart contract to execute.
